(19) United States
(12) Patent Application Publication
(10) Pub. No.: US 2007/0236381 A1
(43) Pub. Date: Oct. 11, 2007

(54) APPLIANCE-OPERATING DEVICE AND APPLIANCE OPERATING METHOD

(75) Inventors: Kazushige Ouchi, Kanagawa (JP); Takuji Suzuki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/686,003

(22) Filed: Mar. 14, 2007

(30) Foreign Application Priority Data
Mar. 27, 2006 (JP) 2006-086514

(51) Int. Cl. G08C 19/12; G08C 19/00

(52) U.S. Cl. 341/176; 340/825.72; 340/539.11; 348/734; 340/825.69

(57) ABSTRACT

An appliance-identifying unit identifies an appliance to be operated, by referring to room information and position information of the appliance stored in a room-information database, based on an operation vector generated from information on a direction and a distance of the appliance. An operation-contents recognizing unit recognizes contents of an operation of the appliance. An operation-command generating unit generates an operation command for operating the appliance from an operation-command database based on the recognized contents of the operation. An operation-command transmitting unit transmits the generated operation command to the identified appliance.

### CROSS-REFERENCE TO RELATED APPLICATIONS

This application is based upon and claims the benefit of priority from the prior Japanese Patent Application No. 2006-086514, filed on Mar. 27, 2006; the entire contents of which are incorporated herein by reference.

### BACKGROUND OF THE INVENTION

1. Field of the Invention

The present invention relates to an appliance-operating device and an appliance operating method for operating an appliance.

2. Description of the Related Art

Many of the appliances in the home come with a remote control of their own. It is common that there are a plurality of remote controls in one room. In this situation, to operate each of the appliances, the user picks up in his/her hand the remote control corresponding to the appliance and performs a desired operation. However, it is often the case that the user cannot find the corresponding remote control easily. The main reason of this problem is that the plurality of remote controls are placed in one room. One of the ideas invented to solve this problem is a multi remote control that makes it possible to operate a plurality of appliances with a single remote control (For example, see JP-A 2003-078779 (KOKAI)).

However, to operate appliances with a multi remote control as disclosed in JP-A 2003-078779, it is necessary to customize, for each operation target appliance, the button to select the operation target appliance and the operation buttons for the selected appliance or the operation buttons that are used in common among all of the appliances. Thus, the number of buttons provided on the remote control becomes large. Also, it is necessary to operate the buttons a plurality of times before performing a desired operation. Thus, a problem arises where the operation becomes complicated.

To cope with this problem, there has been an idea to make it possible to control a plurality of appliances with simple operations, using a single remote control, by incorporating a special function into each of the appliances so that it is possible to identify the appliances from one other. However, it is not possible to apply this system to other appliances that have conventionally been used.

There has been another approach to the problem, in which special commands, like gestures are used to identify each of the appliances. In this system, however, the user is required to learn the commands. Thus, the user needs to have a certain amount of training before using the appliances.

### SUMMARY OF THE INVENTION

A device for operating an appliance, according to one aspect of the present invention, includes an operation-start detecting unit that detects a start of operation of the appliance from an action of pointing at the appliance; a direction detecting unit that detects, when the start of the operation of the appliance is detected, a direction of the appliance; a distance detecting unit that detects, when the start of the operation of the appliance is detected, a distance to the appliance; a room-information database that stores room information of a room in which the appliance is installed and position information of the appliance in the room, the room information including information on a configuration and a dimension of the room; an appliance-identifying unit that identifies the appliance by referring to the room information and the position information stored in the room-information database, based on an operation vector generated from the direction and the distance of the appliance; an operation-contents recognizing unit that recognizes contents of the operation of the appliance; an operation-command database that stores an operation command for operating the appliance; an operation-command generating unit that generates an operation command for operating the appliance from the operation command stored in the operation-command database based on the contents of the operation recognized by the operation-contents recognizing unit; and an operation-command transmitting unit that transmits the operation command generated by the operation-command generating unit to the appliance identified by the appliance-identifying unit.

A method of operating an appliance, according to another aspect of the present invention, includes detecting a start of operation of the appliance from an action of pointing at the appliance; detecting, when the start of the operation of the appliance is detected, a direction of the appliance; detecting, when the start of the operation of the appliance is detected, a distance to the appliance; identifying the appliance by referring to room information of a room in which the appliance is installed and position information of the appliance in the room stored in a room-information database, the room information including information on a configuration and a dimension of the room, based on an operation vector generated from the direction and the distance of the appliance; recognizing contents of the operation of the appliance; generating an operation command for operating the appliance from an operation command stored in an operation-command database, based on the contents of the operation recognized at the recognizing; and transmitting the operation command generated at the generating to the appliance identified at the identifying.

### BRIEF DESCRIPTION OF THE DRAWINGS

FIG. 1 is a schematic drawing for explaining an environment in which an appliance-operating device according to a first embodiment of the present invention is used;

FIG. 2 is a plan view of the appliance-operating device;

FIG. 3 is a block diagram of a schematic configuration of a control system in the appliance-operating device;

FIG. 4 is a block diagram of a functional configuration pertaining to an appliance-operation control processing according to the first embodiment;

FIG. 5 is a drawing for explaining a screen for measuring a room configuration;

FIG. 6 is a drawing for explaining a screen for specifying an operation target appliance;

FIG. 7 is a plan view of an example in which a specification instruction is provided using a light emitting diode (LED), instead of a display unit;

FIG. 8 is a graph for explaining an example of an acceleration that is detected during a pointing movement (i.e. an aiming movement) while the appliance-operating device is attached to the arm of a user;

FIG. 9 is a drawing for explaining XYZ-axis directions in a situation where the appliance-operating device is attached to the arm of a user;

FIG. 10 is a schematic flowchart of a procedure in a room-information generation processing performed by a room-information generating unit;

FIG. 11 is a drawing for explaining examples of results of a measuring process of directions and distances;

FIG. 12 is a drawing for explaining an example of a horizontal direction in room information generated by the room-information generating unit;

FIG. 13 is a drawing for explaining an example of a vertical direction in the room information generated by the room-information generating unit;

FIG. 14 is a drawing for explaining an example of a correction made on a result of measuring a distance;

FIG. 15 is a drawing for explaining an example of how operation target appliances are positioned;

FIG. 16 is a drawing for explaining an example of the room information stored in a room-information database (DB);

FIG. 17 is a schematic flowchart of a procedure in an operation control processing performed on the operation target appliance;

FIG. 18 is a flowchart of a procedure in an appliance judgment processing using a first method for judging the operation target appliance;

FIG. 19 is a conceptual drawing corresponding to FIG. 18;

FIG. 20 is a flowchart of a procedure in an appliance judgment processing using a second method for judging the operation target appliance;

FIG. 21 is a conceptual drawing corresponding to FIG. 20;

FIG. 22 is a drawing for explaining an example in which an operation-target-candidate display unit is included in each of the operation target appliances;

FIG. 23 is a drawing for explaining command attributes that are used in common among appliances;

FIGS. 24A and 24B are graphs for explaining examples of changes in the acceleration when an ON movement (a clockwise turn) and an OFF movement (a counterclockwise turn) are made with the appliance-operating device;

FIGS. 25A and 25B are graphs for explaining examples of changes in the acceleration when an UP movement (up) and a DOWN movement (down) are made with the appliance-operating device;

FIGS. 26A and 26B are graphs for explaining examples of changes in the acceleration when a forward movement (right) and a backward movement (left) are made with the appliance-operating device;

FIG. 27 is a plan view of an appliance-operating device that is designed to be held in a user's hand;

FIG. 28 is a block diagram of a functional configuration of an appliance-operation control processing performed by the appliance-operating device;

FIG. 29 is a system configuration diagram of an example of a system configuration according to a second embodiment of the present invention; and

FIG. 30 is a block diagram of a functional configuration pertaining to an appliance-operation control processing according to the second embodiment.

### DETAILED DESCRIPTION OF THE INVENTION

Exemplary embodiments of an appliance-operating device and an appliance operating method according to the present invention will be explained in detail, with reference to the accompanying drawings.

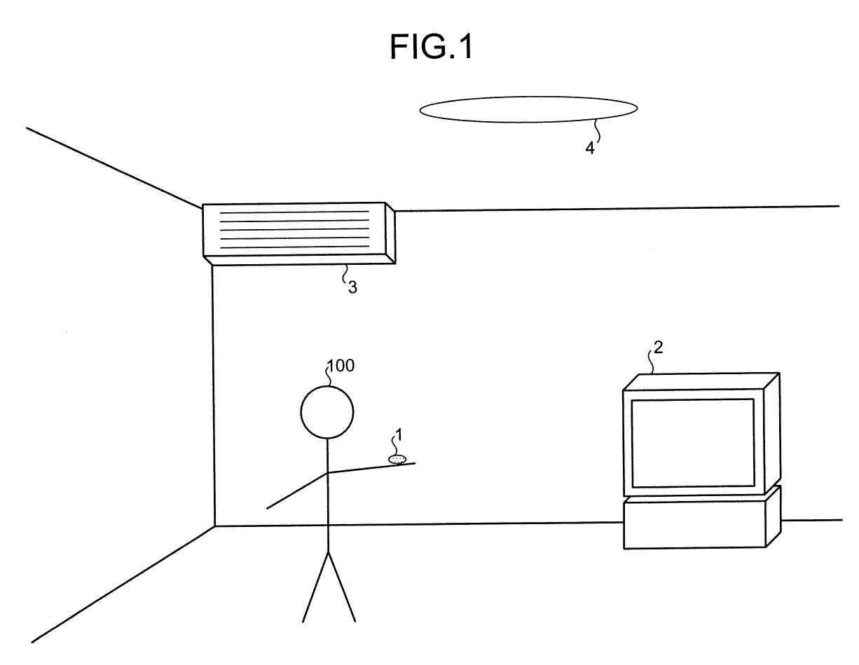

A first embodiment of the present invention will be explained with reference to FIG. 1 through FIG. 28. As shown in FIG. 1, an appliance-operating device 1 according to the first embodiment is used while being held by a user 100 in his/her hand or while being attached to a part of the body of the user 100. The appliance-operating device 1 makes it possible for the user 100 to control a plurality of appliances in the home (for example, a television 2, an air conditioner 3, and a light 4) with intuitive operations.

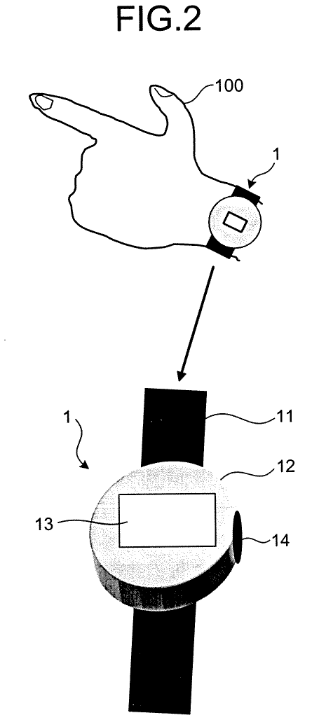

As shown in FIG. 2, the appliance-operating device 1 is of a wristwatch type and can be attached to the wrist of the user 100. The appliance-operating device 1 includes an attachment belt 11, a device main body 12, a display unit 13 that displays, for example, the contents of an instruction, and a sensor window 14 through which an infrared is emitted. After the user 100 attaches the appliance-operating device 1 to his/her arm, using the attachment belt 11, he/she is able to control the plurality of appliances in the home (for example, the television 2, the air conditioner 3, and the light 4) by moving his/her arm.

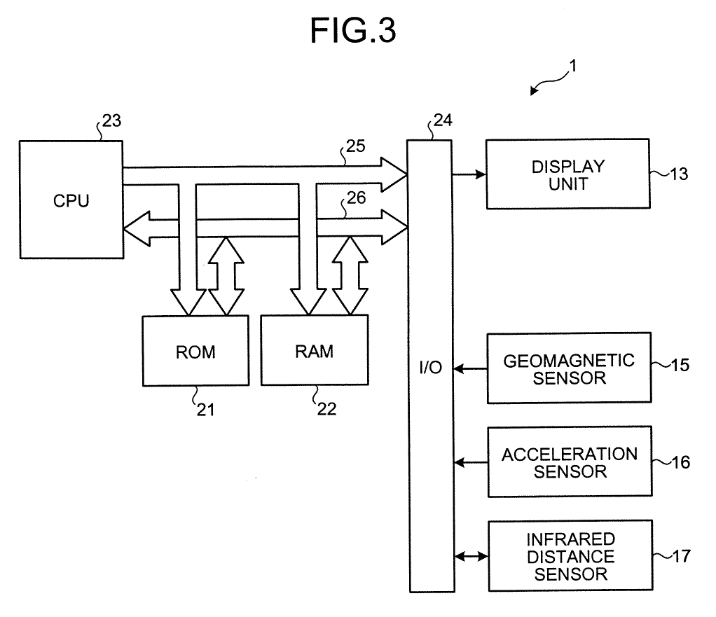

Next, an example of a schematic configuration of a control system in the appliance-operating device 1 will be explained with reference to the block diagram shown in FIG. 3. The control system includes a read only memory (ROM) 21, a random access memory (RAM) 22, and a central processing unit (CPU) 23 that constitute a microcomputer. The CPU 23 is in charge of controlling the appliance-operating device 1, according to a control program stored in the ROM 21. The RAM 22 is used as a work area for, for example, temporarily storing therein the data that is necessary in various types of processing. The ROM 21 stores therein various types of programs including a program used for controlling each of the plurality of appliances (for example, the television 2, the air conditioner 3, and the light 4).

Connected via an Input/Output (I/O) interface 24 are the display unit 13 and other input output units such as a geomagnetic sensor 15, an acceleration sensor 16, and an infrared distance sensor 17 in which an infrared LED is used, that are necessary in the controlling of the appliance-operating device 1. The CPU 23, the ROM 21, the RAM 22, the I/O interface 24 are connected to one another via an address bus 25 and a data bus 26 so that addresses are specified, and data is input and output to and from these units.

Next, of various types of computation processing that are performed by the CPU 23 included in the appliance-operating device 1 according to the programs stored in the ROM 21, an appliance-operation control processing, which is a characteristic processing of the first embodiment, will be explained.

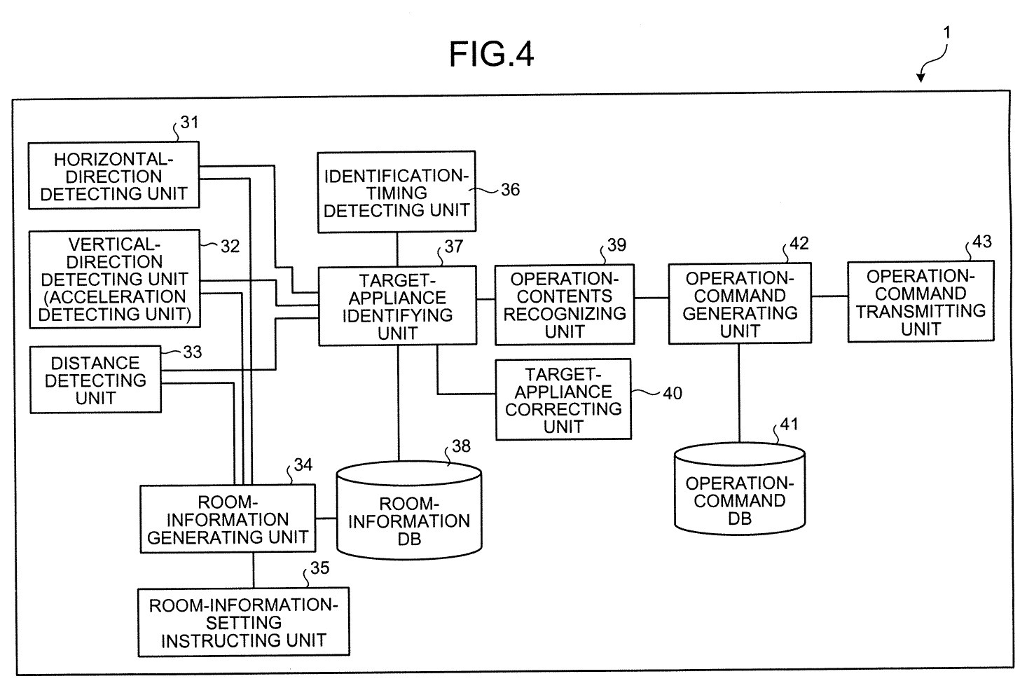

As shown in FIG. 4, as a result of the CPU 23 operating according to the program stored in the ROM 21, the appliance-operating device 1 includes a horizontal-direction detecting unit 31, a vertical-direction detecting unit (acceleration detecting unit) 32, a distance detecting unit 33, a room-information generating unit 34, a room-information-setting instructing unit 35, a judgment-timing detecting unit 36 that serves as an operation-start detecting unit, a target-appliance-identifying unit 37, a room-information database (DB) 38, an operation-contents recognizing unit 39, a target-appliance-changing unit 40, an operation-command database (DB) 41 that stores therein various operation commands, an operation-command generating unit 42, and an operation-command transmitting unit 43 that transmits an operation command to an operation target appliance (for example, the television 2, the air conditioner 3, or the light 4).

The horizontal-direction detecting unit 31 detects an angle of the appliance-operating device 1 in a horizontal direction, using the geomagnetic sensor 15, when the user 100 points the appliance-operating device 1 at an operation target appliance (for example, the television 2, the air conditioner 3, or the light 4).

The vertical-direction detecting unit (acceleration detecting unit) 32 detects an angle of the appliance-operating device 1 in a vertical direction, using the acceleration sensor 16 that detects an inclination of each axis with respect to a gravitational acceleration. The sensor to be used is not limited to the acceleration sensor 16. It is acceptable to use any other sensor as long as it is possible to detect a vertical direction. For example, when a three-axis geomagnetic sensor is used, it is possible to detect not only a horizontal direction, but also a vertical direction. However, when the acceleration sensor 16 is used, it is possible to measure movements of the user 100. Thus, an advantageous feature is achieved where it is possible for the operation-contents recognizing unit 39 to recognize the contents of an operation indicated by a movement of the user 100.

The distance detecting unit 33 detects a distance between an operation target appliance and the appliance-operating device 1, using the infrared distance sensor 17 in which an infrared LED is used. The sensor to be used is not limited to the infrared distance sensor 17. It is acceptable to use any other type of sensor as long as it is possible to measure the distance to an operation target appliance. For example, an ultrasonic distance sensor or a laser distance sensor may be used. However, when the infrared distance sensor 17 is used, an advantageous feature is achieved where it is possible to use the infrared LED that is included in the operation-command transmitting unit 43, not only as an LED for the transmission purposes, but also as an LED for the distance detection purposes.

The room-information generating unit 34 generates room information from a detection result of the horizontal-direction detecting unit 31, a detection result of the vertical-direction detecting unit (acceleration detecting unit) 32, and a detection result of the distance detecting unit 33. The room-information-setting instructing unit 35 provides an instruction indicating a specifying method for the user 100 so that the room information is generated. The room-information DB 38 stores therein the room information generated by the room-information generating unit 34.

The judgment-timing detecting unit 36 detects timing at which an operation target appliance (for example, the television 2, the air conditioner 3, or the light 4) is identified. The target-appliance-identifying unit 37 identifies the operation target appliance (for example, the television 2, the air conditioner 3, and the light 4). The target-appliance-changing unit 40 makes a change when the operation target appliance identified by the target-appliance-identifying unit 37 is wrong.

The operation-contents recognizing unit 39 recognizes the contents of an operation performed by the user 100 on the operation target appliance (for example, the television 2, the air conditioner 3, or the light 4), using the acceleration sensor 16. The operation-command generating unit 42 generates an operation command by extracting the operation command from the operation-command DB 41, based on the contents of the operation recognized by the operation-contents recognizing unit 39. The operation-command transmitting unit 43 transmits the operation command generated by the operation-command generating unit 42 to the operation target appliance, using the infrared distance sensor 17. The operation-command DB 41 stores therein operation commands that are related to the operations of each operation target appliance.

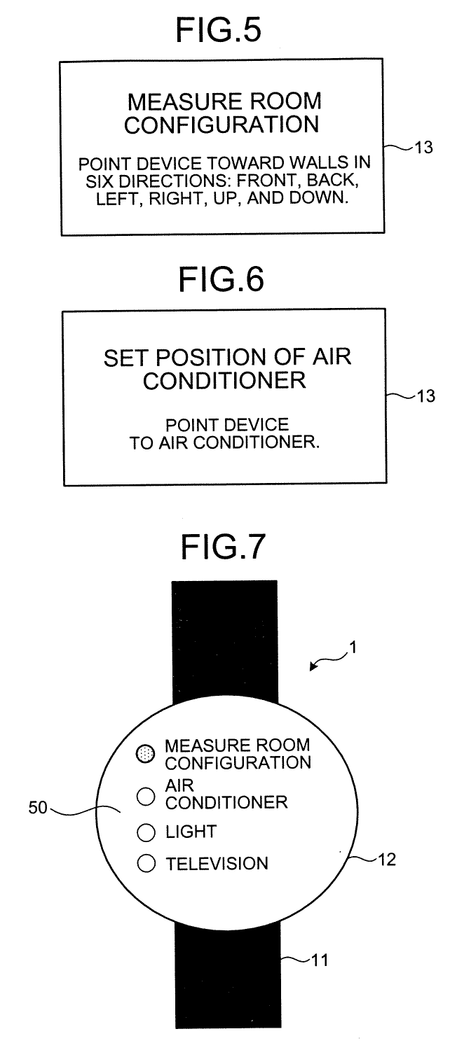

Firstly, the method of instruction used by the room-information-setting instructing unit 35 will be explained. To generate the room information (information of a room), the room-information-setting instructing unit 35 sequentially displays, on the display unit 13 included in the appliance-operating device 1, a screen for measuring the configuration of a room as shown in FIG. 5 and a screen for specifying an operation target appliance being registered in advance as shown in FIG. 6 and provides an instruction indicating a specifying method for the user. The order in which the room configuration is specified and the operation target appliance is specified may be reversed. Also, the instruction does not have to be displayed in text. It is acceptable to display the instruction with an icon or the like.

The user 100 performs a specifying (or measuring) operation according to the display on the display unit 13. According to the first embodiment, because the appliance-operating device 1 includes the acceleration sensor 16, the operation-contents recognizing unit 39 recognizes the contents of the specifying operation by detecting a pointing movement of the user 100 based on the acceleration and using the detected pointing movement as a trigger of the measuring process. If the appliance-operating device 1 is configured so as not to include the acceleration sensor 16, the appliance-operating device 1 may include a button used in the specifying operation so that the button is pushed every time the specifying operation is performed.

FIG. 7 is a plan view of an example in which a specification instruction is provided using an LED 50, instead of the display unit 13. An LED that corresponds to a specifying operation being currently performed is turned on, and the specifying process that corresponds to the LED that has been turned on is performed. Also, when the appliance-operating device 1 includes the LED 50, instead of the display unit 13, a pointing movement of the user or a button is used as a trigger of the measuring process. As another example besides these, it is also acceptable to provide the specification instruction with audio.

The description above is based on a premise that the types of operation target appliances are registered in advance. However, another arrangement is also acceptable in which it is possible to dynamically specify the types of operation target appliances on the display unit 13 or with the LED 50, if an operation button or the like is included in the appliance-operating device 1.

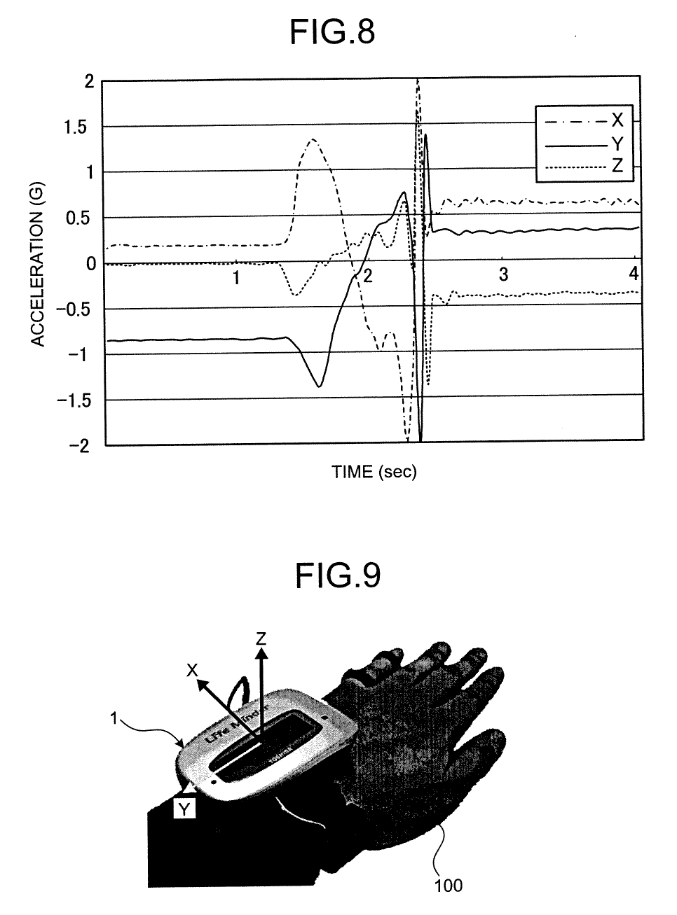

Next, the technical feature of detecting the pointing movement based on the acceleration will be briefly explained. As shown in FIG. 8, when the user 100 makes a pointing movement, a characteristic waveform appears in both the X-axis direction (see FIG. 9) and the Y-axis direction (see FIG. 9) or in one of the X-axis direction and the Y-axis direction. Based on this characteristic, it is possible to detect the pointing movement through a threshold value processing or a recognition processing such pattern matching. For example, an upper threshold value and a lower threshold value may be specified so that when the waveform reaches the threshold values and a period of time between the threshold values is within a predetermined length, it is recognized that a pointing movement has been made.

Next, the room-information generation processing performed by the room-information generating unit 34 will be explained. The room-information generation processing is performed by the room-information generating unit 34 when the user 100 operates the appliance-operating device 1 for the first time, by semi-automatically specifying the room information (i.e. the information of the room, the types of appliances, and the position information).

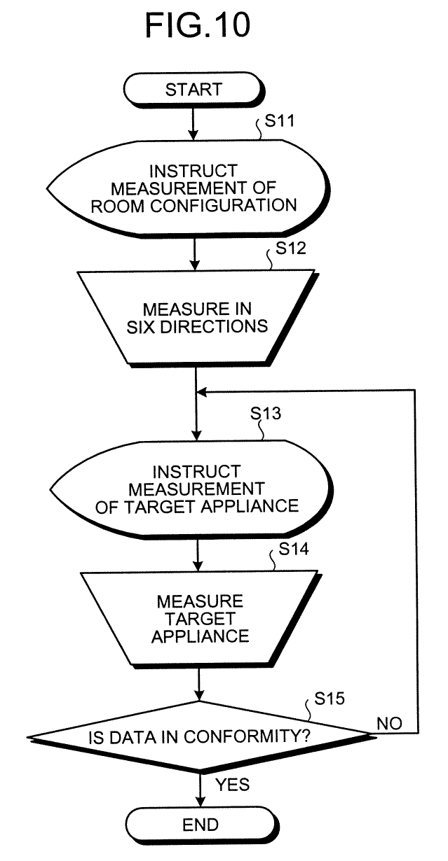

As shown in FIG. 10, firstly, the room-information-setting instructing unit 35 displays the screen for measuring the configuration of a room, as shown in FIG. 5, on the display unit 13, and thus the user 100 is instructed to measure the configuration of the room (step S11). The user 100 measures the configuration of the room according to the screen for measuring the configuration of the room being displayed on the display unit 13. On the screen for measuring the configuration of the room as shown in FIG. 5, a text reading “Please point the device at the walls in a total of six directions: front, back, left, right, up, and down.” is displayed. At this point in time, each of the geomagnetic sensor 15, the acceleration sensor 16, and the infrared distance sensor 17 is ready to perform a detection process. It should be noted, however, if it is necessary to initialize the geomagnetic sensor 15 (e.g. by moving the device 3600 in a horizontal direction), the initializing process is performed before the process of measuring the configuration of the room.

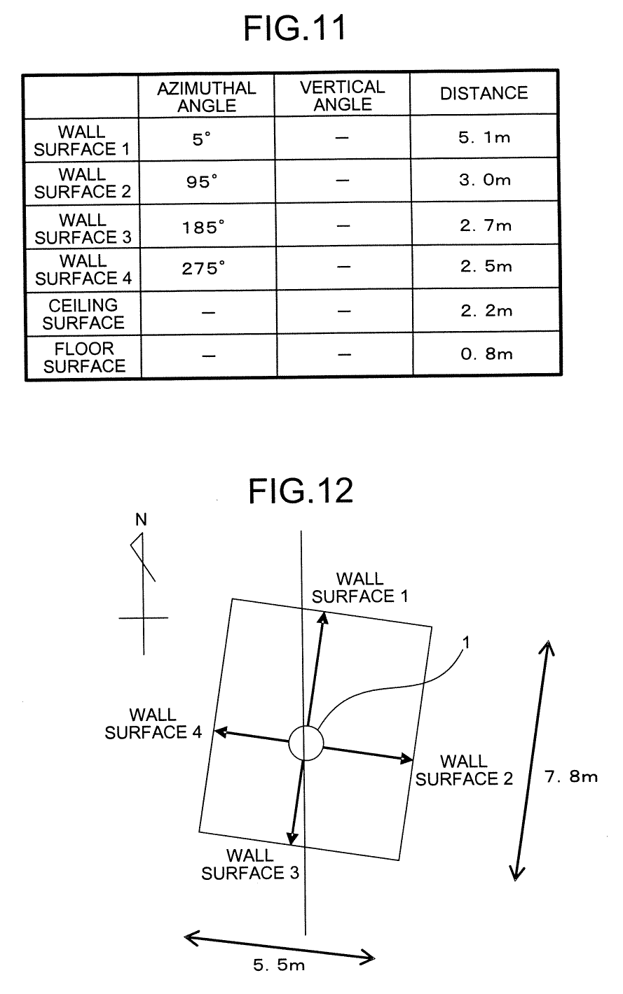

Subsequently, at step S12, a measuring process of the configuration of the room, as displayed on the display unit 13, is performed. On an assumption that the room is in the shape of a rectangular solid, the user 100 attaches the appliance-operating device 1 to his/her arm and performs a pointing movement (i.e. an aiming movement) from his/her current position toward each of a total of six directions, namely, toward the wall surfaces (i.e. four surfaces: to the front, to the back, to the left, and to the right), a ceiling surface, and a floor surface. When the pointing movement is performed, the horizontal-direction detecting unit 31, the vertical-direction detecting unit (acceleration detecting unit) 32, and the distance detecting unit 33 measure the horizontal/vertical direction and a distance in a direction that is perpendicular to each of the six directions. FIG. 11 is a drawing for explaining examples of results of the measuring process of directions and distances.

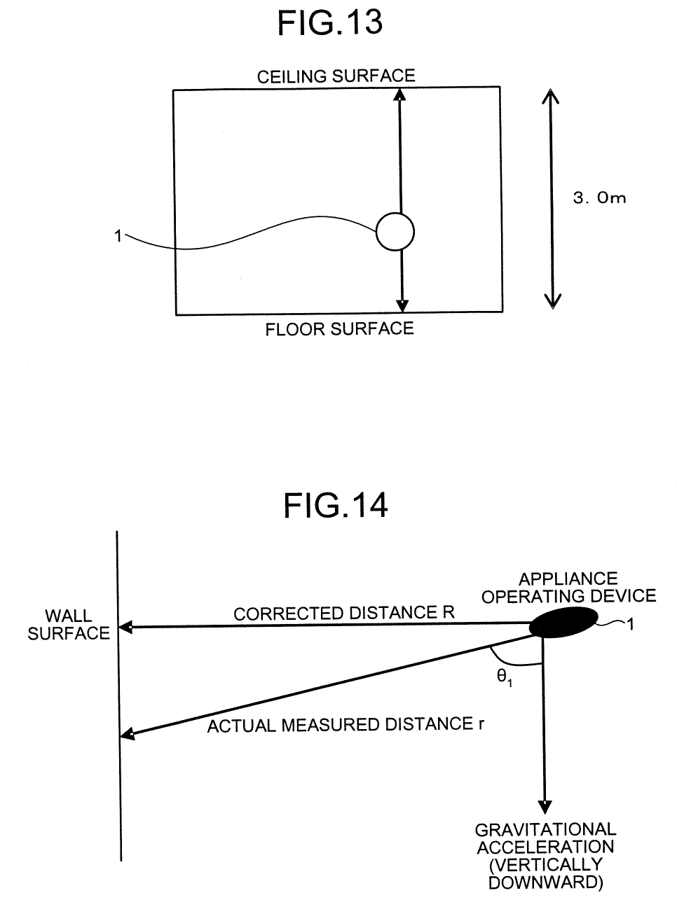

Next, based on the results of the measuring process shown in FIG. 11, an example of the room information generated by the room-information generating unit 34 will be explained by dividing it into a horizontal direction (see FIG. 12) and a vertical direction (see FIG. 13), to make it easy to understand. In this situation, a vertical angle (an angle with respect to a gravitational acceleration) is not absolutely necessary for generating the room information, but the vertical angle may be used to correct a result of the measuring process of the distance. For example, let us assume that the appliance-operating device 1 has measured an actual measured distance to an arbitrarily selected wall surface as r, while θ=θ₁ is satisfied, as shown in FIG. 14, although the appliance-operating device 1 should have measured a distance using an angle θ=90° with respect to the gravitational acceleration of the appliance-operating device 1 obtained when the measuring process is performed. In this situation, the correct value (i.e. a corrected distance R) in the horizontal direction from the user 100 is expressed as R=rcos(90−θ). By correcting each of the measured values in this way, it is possible to generate more accurate room information. This operation is performed while the user 100 has his/her arm stretched out. Thus, it is possible to generate even more accurate room information by correcting the results of the measuring process while taking the length of the arm of the user 100 into account.

The room-information generating unit 34 stores the room information obtained in the measuring process performed by the user 100 from his/her current position into the room-information DB 38.

When the measuring process of the room configuration is finished, a screen for specifying an operation target appliance, as shown in FIG. 6, is displayed on the display unit 13 by the room-information-setting instructing unit 35. Thus, an instruction indicating that the operation target appliance (in the present example, one of the television 2, the air conditioner 3, and the light 4, that have been registered in advance) should be specified is provided (step S13). The user 100 specifies the operation target appliance according to the screen for specifying the operation target appliance being displayed on the display unit 13. According to the screen for specifying the operation target appliance as shown in FIG. 6, a text reading “Please point the device at the air conditioner” is displayed. The room-information-setting instructing unit 35 sequentially displays operation target appliances to be specified in an order that is determined in advance. Another arrangement is acceptable in which the user 100 designates which operation target appliance is to be specified in the specifying process.

Subsequently, at step S14, the specifying process of the operation target appliance displayed on the display unit 13 is performed. The user 100 attaches the appliance-operating device 1 to his/her arm and performs a pointing movement (i.e. an aiming movement) from his/her current position in the direction of the operation target appliance (i.e. the air conditioner 3). When the pointing movement is performed, the horizontal-direction detecting unit 31, the vertical-direction detecting unit (acceleration detecting unit) 32, and the distance detecting unit 33 measure the horizontal/vertical direction and a distance to the operation target appliance (i.e. the air conditioner 3).

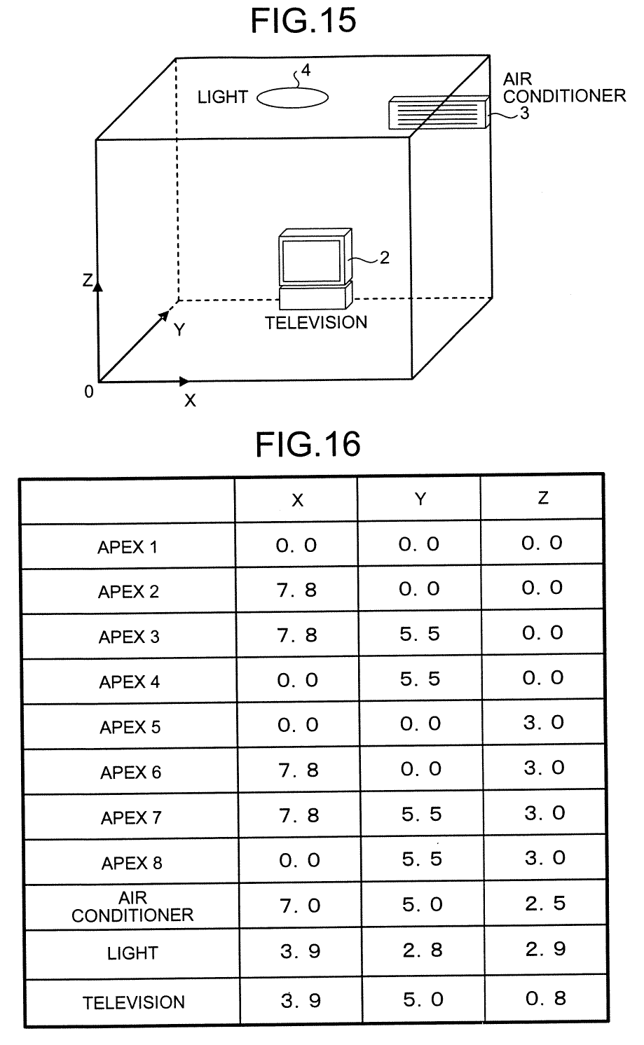

Next, an example of the measuring process performed on each of the operation target appliances that are positioned as shown in FIG. 15 will be explained. In this example, an arbitrarily selected point in the room is used as the point of origin. The position of each of the operation target appliances is stored using relative coordinates of a coordinate system in which the directions toward the walls from the point of origin are used as the axes. The point of origin may be, for example, a corner on the floor that is located at a northernmost position.

The room-information generating unit 34 converts the information related to the direction and the distance of each of the operation target appliances that is measured by the user 100 from his/her current position into a positional coordinate system with respect to the point of origin in the room and stores the converted information into the room-information DB 38. An example of the room information stored in the room-information DB 38 is shown in FIG. 16.

The instruction for specifying an operation target appliance (step S13) and the process of measuring the horizontal/vertical direction and the distance from the current position of the user 100 to the operation target appliance (step S14) are sequentially performed on each of all the operation target appliances (in the present example, the television 2, the air conditioner 3, and the light 4 that have been registered in advance).

At step S15, when the room information is apparently not in conformity with actuality, for example, when the coordinates of the operation target appliance indicate a positional relationship where the operation target appliance is positioned on the outside of the room configuration, the user 100 is asked to perform the specifying process once again.

It is acceptable to perform the series of procedures in the room-information generation processing as necessary, not only when the appliance-operating device 1 starts being used for the first time, but also when the positions of the operation target appliances have been changed or when errors in measured values have become evidently large.

Alternatively, instead of performing the specifying operation as described above, it is possible to specify the room information manually on an external terminal device such as a personal computer, so that the specified information is transferred to the room-information DB 38 via a communicating unit (not shown). To specify the room information on the personal computer, the data as shown in FIG. 16 may be directly edited on the personal computer, or the data may be specified graphically using a special tool prepared for the purpose of specifying the room information.

Next, the procedure that is performed so as to actually control the operation of each of the operation target appliances while the appliance-operating device 1 is attached to the arm of the user 100, after the room information has been specified, will be explained.

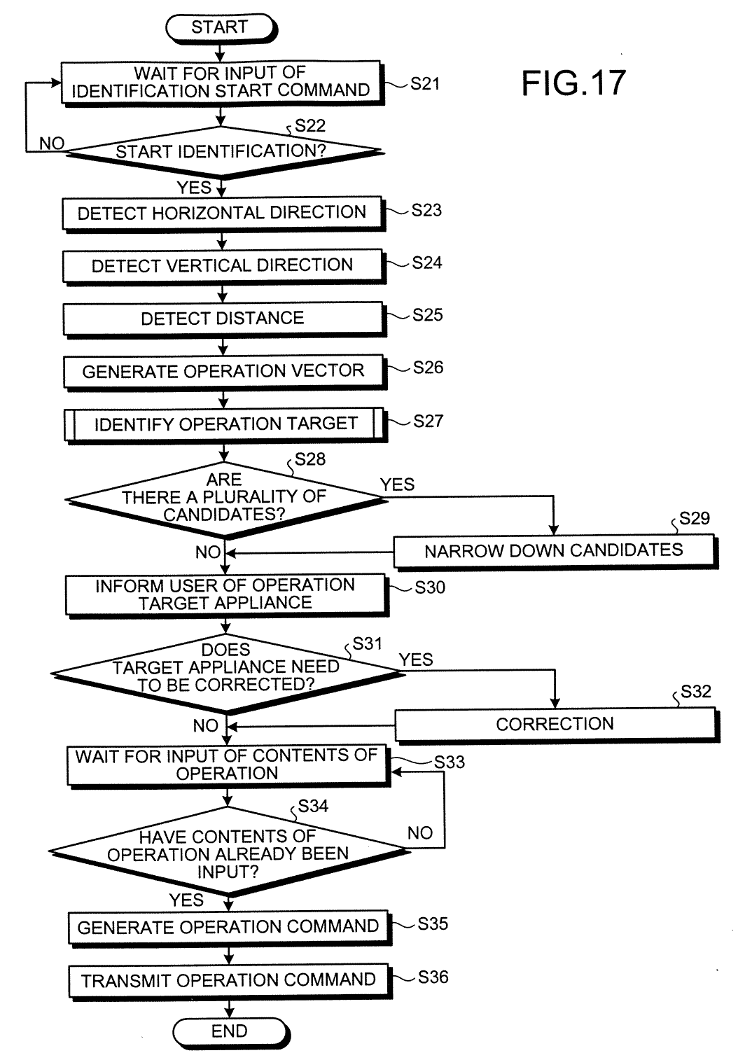

As shown in FIG. 17, firstly, the judgment-timing detecting unit 36 detects a confirmation operation of selecting an operation target appliance (step S21 and step S22). During the confirmation operation, the operation to select the operation target appliance is detected based on an acceleration generated from a pointing movement (i.e. an aiming movement) performed by the user 100 at the operation target appliance (for example, the television 2, the air conditioner 3, or the light 4), while the appliance-operating device 1 is attached to his/her arm so that the detected selection operation is used as an input of confirmation. As explained earlier, the pointing movement is detected based on the acceleration. When the appliance-operating device 1 is configured so as to include an operation button or the like, another arrangement is acceptable in which the user 100 attaches the appliance-operating device 1 to his/her arm, performs a pointing movement (i.e. an aiming movement) at the operation target appliance (for example, the television 2, the air conditioner 3, or the light 4), and pushes the button.

When the operation target appliance has been selected as described above (step S22: Yes), the following detection processes are sequentially performed: a horizontal direction detection performed by the horizontal-direction detecting unit 31 (step S23), a vertical direction detection performed by the vertical-direction detecting unit (acceleration detecting unit) 32 (step S24), and a distance detection performed by the distance detecting unit 33 (step S25). The order in which these detection processes are performed is not limited to this example.

When all the measuring processes are finished, an operation vector is generated based on the results of the measuring processes (step S26). The operation vector is a vector that is determined based on a horizontal angle (e.g. an angle measured clockwise from due north), a vertical angle (e.g. an angle with respect to a gravitational acceleration), and a distance from the appliance-operating device 1 to the operation target appliance.

Next, the target-appliance-identifying unit 37 identifies the operation target appliance, based on the operation vector generated at step S26 (step S27). In this situation, it is not possible to determine the position of the appliance-operating device 1 based on the measured information obtained in the present example. Thus, an operation target appliance candidate is estimated based on the measured information. Of methods that can be used to identify the operation target appliance, two different methods will be explained.

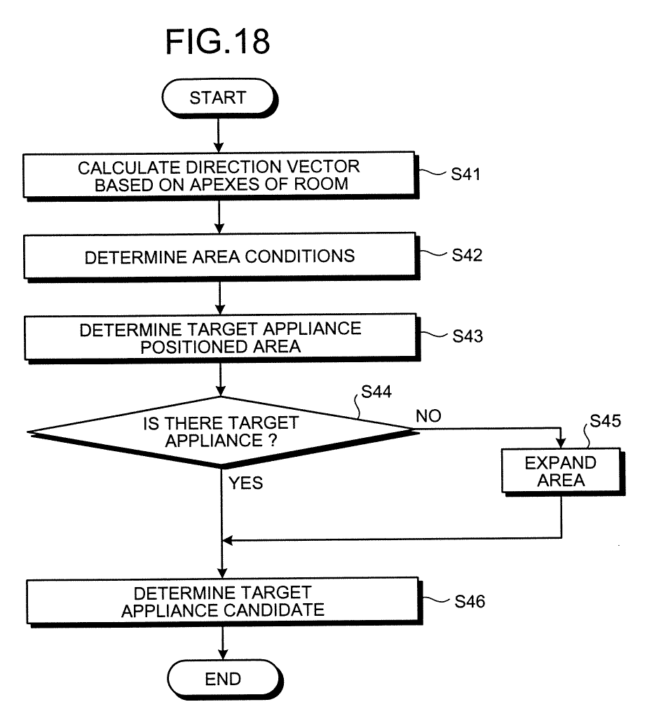

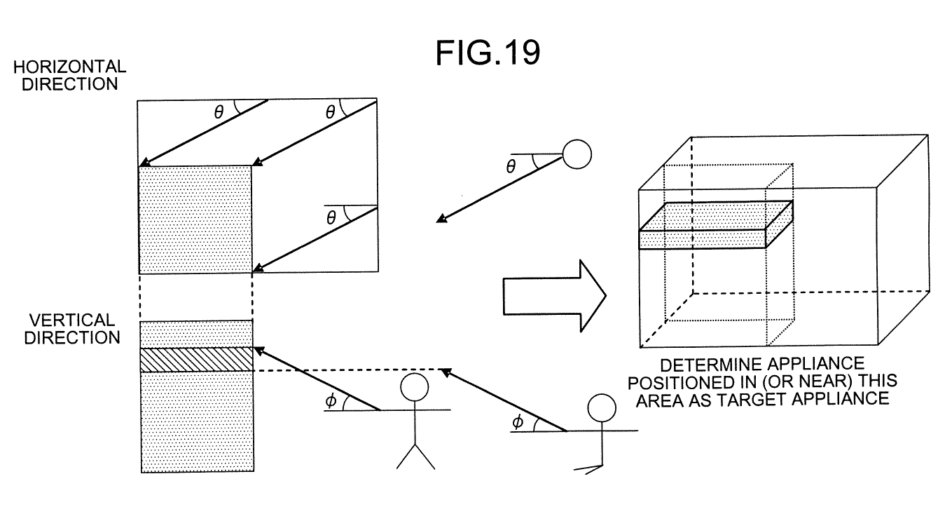

One method is to estimate an area in which the operation target appliance is positioned by extending an operation vector from each of the walls in the room. FIG. 18 is a flowchart of a procedure in the appliance judgment processing using a first method for judging an operation target appliance. FIG. 19 is a conceptual drawing corresponding to FIG. 18.

Firstly, as shown in FIG. 19, a vector is extended from each of the four walls to narrow down possibilities in the horizontal direction (step S41). An area obtained by putting the tips of the vectors within the dimension of the room is determined as a horizontal direction target area (step S42). As for the vertical direction, an operation vector is placed from the height of the user 100 while he/she is standing or sitting down, and thus, a vertical direction target area is determined. Based on a combination of the horizontal direction target area and the vertical direction target area, a target appliance positioned area is estimated (step S43). An appliance that is positioned in the target appliance positioned area is determined as the operation target appliance (step S44: Yes; and Step S46). When there is no appliance that can be a target of the operation in the target appliance positioned area, according to the room-information DB 38 (Step S44: No), an appliance that is positioned closest to the target appliance positioned area is determined as a candidate (step S45).

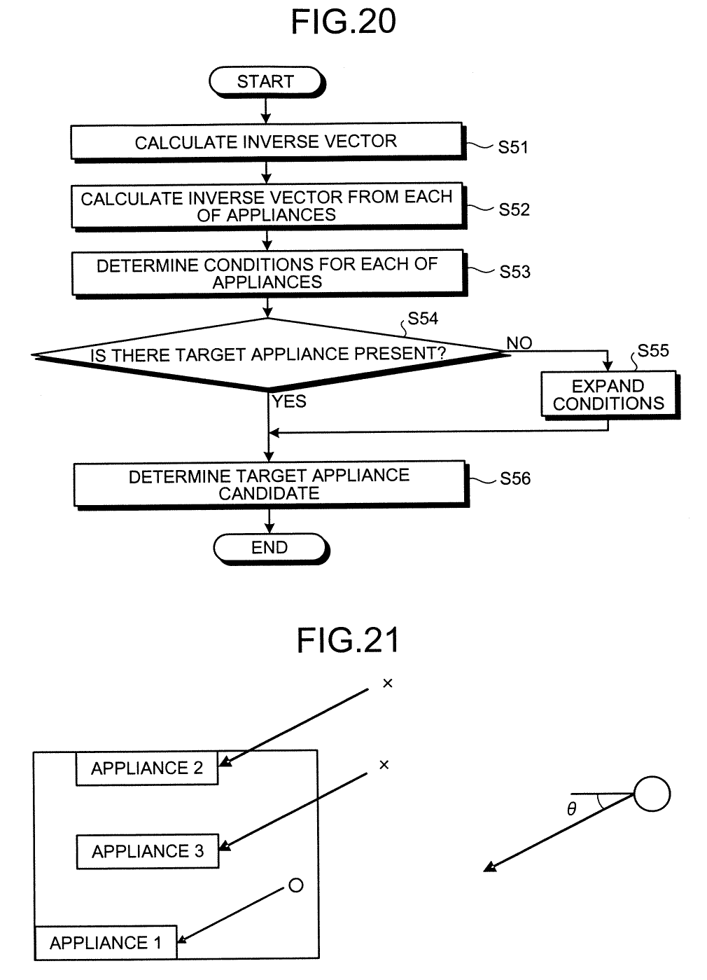

The second method is to generate an inverse vector of the operation vector and to estimate an operation target appliance positioned area. FIG. 20 is a flowchart of a procedure in the appliance judgment processing using a second method for judging an operation target appliance. FIG. 21 is a conceptual drawing corresponding to FIG. 20.

Firstly, as shown in FIG. 21, an inverse vector of the operation vector is generated (step S51). An inverse vector is extended from each of all the operation target appliances (step S52). As a result, the tips of the inverse vectors are supposed to be the operating position of the user 100. Thus, it is identified whether the obtained position is correct as the operating position of the user 100 (step S53). When the obtained position is correct as the operating position of the user 100 (step S54: Yes), the appliance is determined as the operation target appliance (step S56). On the contrary, when the user position is identified to be on the outside of the room, or when the vertical direction position is not within the range of the standing or sitting height of the user, it is identified that the appliance is not relevant. When no operation target appliance has been found (step S54: No), an appliance having the smallest degree of irrelevance is determined as the operation target appliance (step S55), and thus, an operation target appliance candidate has been determined (step S56).

Using the method described above, one or more operation target appliance candidates are determined. If there is more than one operation target appliance candidate (step S28: Yes), the candidates are narrowed down based on a predetermined rule (step S29). For example, the rule may define that the position at which the initial specifying process was performed is determined as a current user position. Alternatively, a history of operations performed on the appliances may be stored, and the rule may define that an appliance having the highest frequency of operation is determined as the operation target appliance.

Thus, the candidates are narrowed down to determine the operation target appliance. However, the operation target appliance candidate may not be the one the user 100 desires to operate.

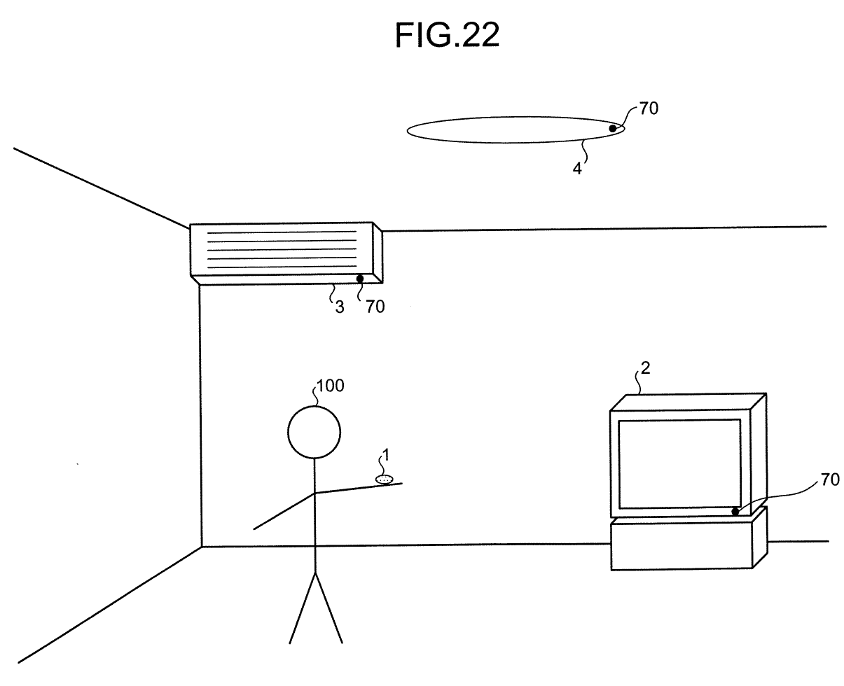

To cope with this situation, according to the first embodiment, at the following step S30, at the point in time when the target-appliance-identifying unit 37 has made a judgment, the operation-command transmitting unit 43 transmits an target candidate command to the operation target appliance that has been determined as a result of the judgment by the target-appliance-identifying unit 37. The target candidate command informs the operation target appliance that the appliance has been selected as the candidate. When having received the target candidate command, the operation target appliance informs the user 100 that the appliance has been selected as the candidate by way of a display. For example, as shown in FIG. 22, each of the operation target appliances may include an operation-target-candidate display unit 70 configured with an LED, so that, when the appliance is selected as a candidate, the LED is turned on to inform the user 100. The method used by the operation target appliance to inform the user 100 is not limited to turning on an LED. It is also acceptable to inform the user 100 with audio or the like.

The user 100 checks the status, and if the appliance the user 100 desires to operate has been selected (Step S31: No), the procedure advances to step S33, and the user 100 inputs an operation command.

On the other hand, when the operation target appliance candidate is not the one the user 100 desires to operate, an input indicating that the operation target appliance needs to be changed is received (step S31: Yes). A change command is input so that the operation target appliance is changed (step S32). To be more specific, when it is confirmed that the change command has been input, the target-appliance-identifying unit 37 transmits an target candidate command to a second candidate and takes the same procedure. As for the input indicating that the operation target appliance should be changed, because the appliance-operating device 1 includes the acceleration sensor 16, a change command is prepared in advance so that the user 100 inputs an operation for changing the operation target appliance to the appliance-operating device 1. To change the operation target appliance, the user performs a pointing movement (i.e. an aiming movement) with the appliance-operating device 1 at the desired operation target appliance. When the appliance-operating device 1 is configured so as to include an operation button or the like, another arrangement is acceptable in which the user 100 performs a pointing movement (i.e. an aiming movement) at the desired operation target appliance and pushes the button.

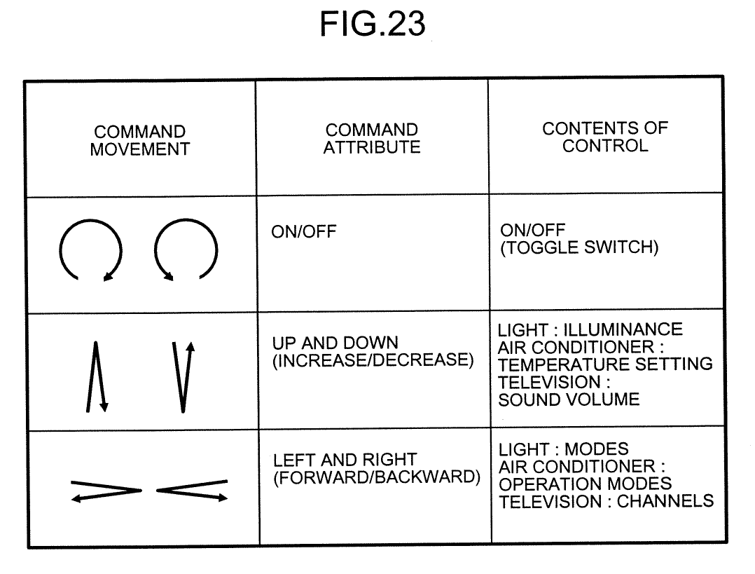

After the operation target appliance has been determined in the manner described above, the appliance-operating device 1 waits until the contents of an operation is input (step S33). As for the input of the contents of the operation, because the appliance-operating device 1 includes the acceleration sensor 16, command attributes, as shown in FIG. 23, that are used in common among the appliances are prepared in advance so that the user 100 instructs the contents of the operation according to the movements (step S34: Yes). Alternatively, another arrangement is acceptable in which the user 100 selects desired contents of operation from various types of contents of operation being displayed on the display unit 13. Accordingly, the operation-contents recognizing unit 39 recognizes the contents of the operation and generate an input.

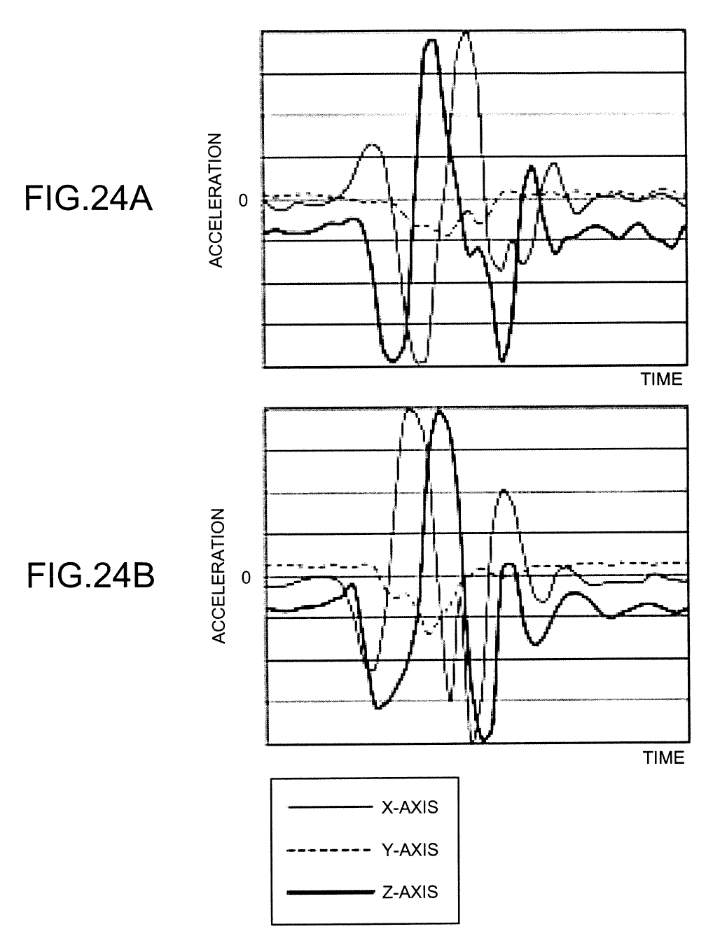

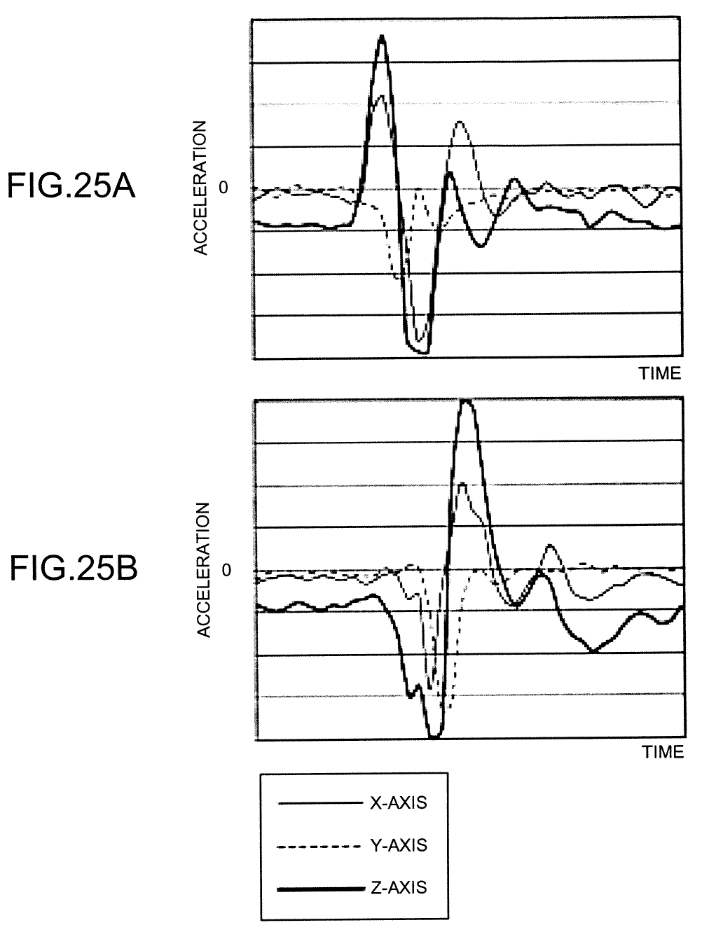

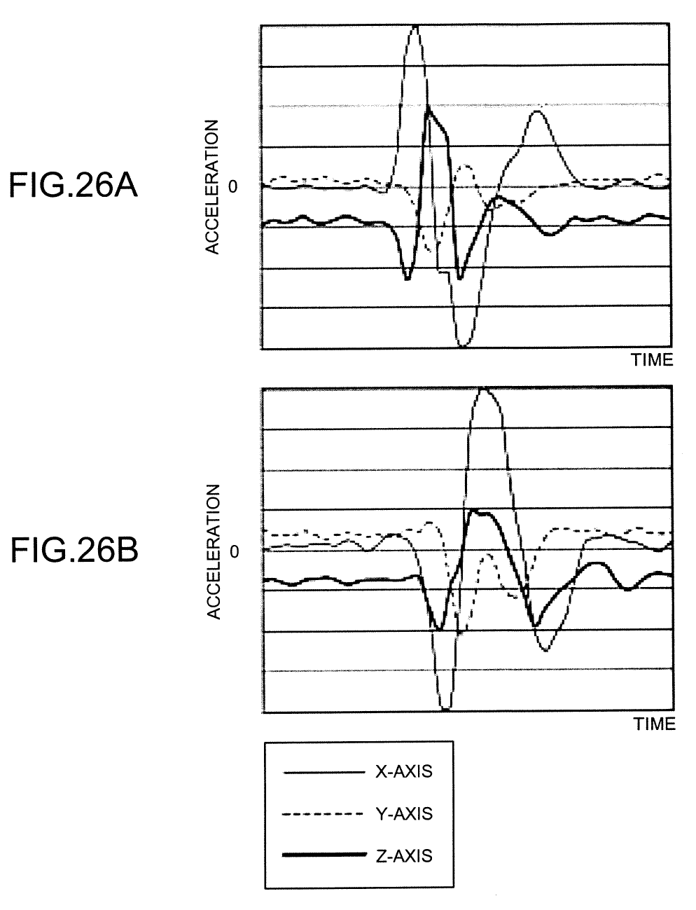

It is a good idea to assign commands that are as intuitive as possible to the command attributes that are used in common among the appliances, as shown in FIG. 23. For example, how many levels of wind volume are changed for the control of an air conditioner, or how many channels are skipped for the control of a television are determined as a control amount. The control amount is recognized based on how many times the control attribute command is performed. As for some of the control attributes that do not include the concept of control amount (e.g. turning the appliance on and off), the control amount does not have to be input. The six types of attribute commands that are shown in FIG. 23 are recognized using a recognition method in which a threshold value cross or pattern matching is used. FIGS. 24A, 24B to FIGS. 26A, 26B show an example of acceleration waveforms that are obtained when a different one of the attribute commands is performed. FIG. 24A and FIG. 24B are graphs for explaining examples of turning the appliance on (right turn) and off (left turn). FIG. 25A and FIG. 25B are graphs for explaining examples of decreasing (down) and increasing (up). FIG. 26A and FIG. 26B are graphs for explaining examples of backward (left) and forward (right).

Next, the operation-command generating unit 42 extracts and generates an operation command from the operation-command DB 41, based on the operation target appliance and the contents of the operation that have been specified in the processing performed so far (step S35). When the operation-command transmitting unit 43 included in the appliance-operating device 1 is of an infrared remote control compatible type, the operation command is generated using a light emission command of the infrared LED. The operation-command DB 41 stores therein, in advance, the infrared LED commands.

Finally, the operation-command transmitting unit 43 transmits the operation command to the operation target appliance, using the infrared distance sensor 17 (step S36).

As explained so far, according to the first embodiment, by pointing at an appliance to be the target of the operation, it is possible to select a desired operation target appliance from among the plurality of appliances (e.g. the television 2, the air conditioner 3, and the light 4) that are positioned in a room. In addition, it is possible to transmit an operation command to the operation target appliance, based on the contents of the operation performed on the selected operation target appliance. Thus, it is possible to operate the plurality of appliances intuitively. Accordingly, it is possible to improve the level of user-friendliness of the appliances on a daily basis.

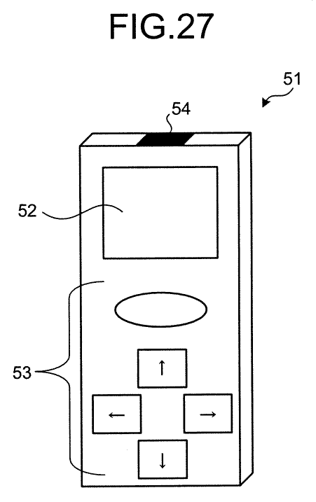

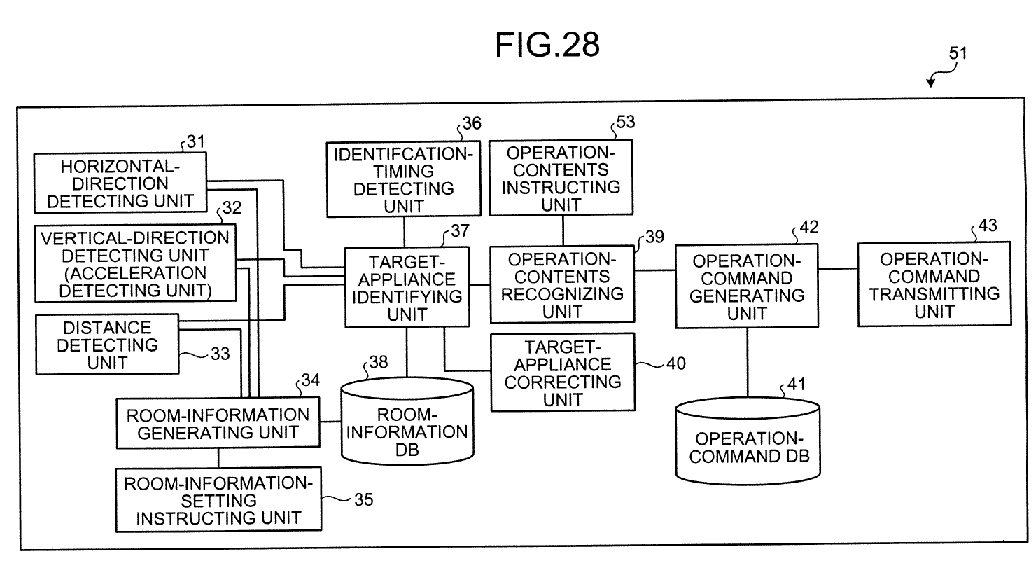

According to the first embodiment, the appliance-operating device 1 is designed so as to be attached to the arm of the user 100. However, the present invention is not limited to this example. It is acceptable to design the appliance-operating device so that the user 100 can hold it in his/her hand, like an appliance-operating device 51 shown in FIG. 27. The appliance-operating device 51 includes a display unit 52 that displays the contents of an instruction from the room-information-setting instructing unit 35, an operation button 53 that serves as an operation-contents instructing unit (see FIG. 28) with which the user 100 directly instructs the contents of an operation, and a sensor window 54 that is used when the distance detecting unit 33 and the operation-command transmitting unit 43 use the infrared distance sensor 17. FIG. 28 is a block diagram of a functional configuration of an appliance-operation control processing performed by the appliance-operating device 51.

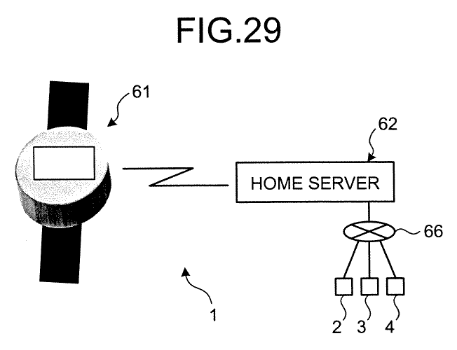

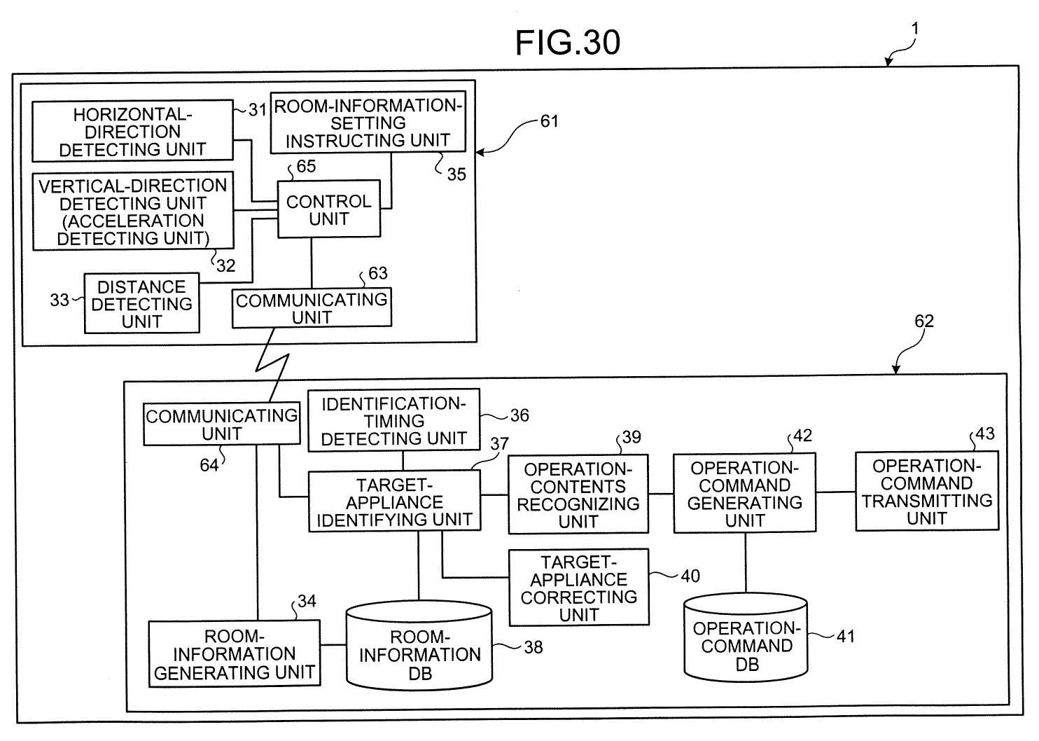

Next, a second embodiment of the present invention will be explained with reference to FIG. 29 and FIG. 30. The constituent elements that are the same as the ones according to the first embodiment are referred to by using the same reference characters, and the explanation thereof will be omitted.

FIG. 29 is a system configuration diagram of an example of a system configuration according to the second embodiment. FIG. 30 is a block diagram of a functional configuration in the appliance-operation control processing according to the second embodiment. According to the second embodiment, the functions of the appliance-operating device 1 according to the first embodiment are divided and included in a wristwatch-type device 61 and a home server 62.

As shown in FIG. 30, the wristwatch-type device 61 and the home server 62 include a communicating unit 63 and a communicating unit 64, respectively. The communicating unit 63 and the communicating unit 64 communicate with each other by way of infrared communication or Bluetooth (trademark) communication. The wristwatch-type device 61 includes the horizontal-direction detecting unit 31, the vertical-direction detecting unit (acceleration detecting unit) 32, the distance detecting unit 33, the room-information-setting instructing unit 35, the communicating unit 63 that communicates with the home server 62, and a control unit 65 that controls the measuring processing and the communicating processing performed by these constituent elements. The home server 62 is a generally-used personal computer, or the like. The home server 62 is connected to each of the operation target appliances (e.g. the television 2, the air conditioner 3, and the light 4) via a network 66 like a local area network (LAN), so that a home information appliance network is structured. The LAN may be a wired network or a wireless network. As a result of a CPU operating according to a program stored in a storage device, the home server 62 includes the room-information generating unit 34, the judgment-timing detecting unit 36, the target-appliance-identifying unit 37, the room-information DB 38, the operation-contents recognizing unit 39, the target-appliance-changing unit 40, the operation-command DB 41, the operation-command generating unit 42, the operation-command transmitting unit 43, and the communicating unit 64 that communicates with the wristwatch-type device 61. According to the second embodiment, commands transmitted by the operation-command transmitting unit 43 are transmitted via the home information appliance network. Thus, each operation command includes an address of the operation target appliance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A device for operating an appliance, the device comprising:
an operation-start detecting unit that detects a start of operation of the appliance from an action of pointing at the appliance;
a direction detecting unit that detects, when the start of the operation of the appliance is detected, a direction of the appliance;
a distance detecting unit that detects, when the start of the operation of the appliance is detected, a distance to the appliance;
a room-information database that stores room information of a room in which the appliance is installed and position information of the appliance in the room, the room information including information on a configuration and a dimension of the room;
an appliance-identifying unit that identifies the appliance by referring to the room information and the position information stored in the room-information database, based on an operation vector generated from the direction and the distance of the appliance;
an operation-contents recognizing unit that recognizes contents of the operation of the appliance;
an operation-command database that stores an operation command for operating the appliance;
an operation-command generating unit that generates an operation command for operating the appliance from the operation command stored in the operation-command database based on the contents of the operation recognized by the operation-contents recognizing unit; and
an operation-command transmitting unit that transmits the operation command generated by the operation-command generating unit to the appliance identified by the appliance-identifying unit.

2. The device according to claim 1, wherein
the direction detecting unit includes:
a horizontal-direction detecting unit that detects a horizontal pointing angle of the appliance-operating device with respect to the appliance; and
a vertical-direction detecting unit that detects a vertical pointing angle of the appliance-operating device with respect to the appliance.

3. The device according to claim 1, wherein
the appliance-identifying unit identifies the appliance by narrowing a range of an area in which the appliance is positioned from the room information stored in the room-information database, based on the operation vector.

4. The device according to claim 1, wherein
the appliance-identifying unit identifies the appliance by calculating an inverse vector of the operation vector from the room information and the position information stored in the room-information database, based on the operation vector.

5. The device according to claim 1, wherein
the operation-command transmitting unit transmits a target candidate command to the appliance identified by the appliance-identifying unit, the target candidate command enabling the appliance to inform that the appliance is selected as a candidate for an operation target to outside.

6. The device according to claim 1, further comprising:
an appliance-changing unit that changes the appliance, when the appliance identified by the appliance-identifying unit is different from a desired appliance to be operated.

7. The device according to claim 1, further comprising:
a room-information-setting instructing unit that issues an instruction for generating information to be stored in the room-information database; and
a room-information generating unit that generates the room information and the position information from results of detection by the direction detecting unit and the distance detecting unit according to the instruction, and stores the generated room information and the generated position information in the room-information database.

8. The device according to claim 7, wherein
the room-information-setting instructing unit issues an instruction for sequentially pointing at a wall surface, a ceiling surface, and a floor surface of the room, in directions that are perpendicular to each other, and sequentially pointing at each appliance to be operated.

9. The device according to claim 1, further comprising:
a communicating unit that receives the room information and the position information set in an external terminal device, wherein
the room-information database is generated from the room information and the position information received by the communicating unit.

10. The device according to claim 1, further comprising:
an acceleration sensor that detects an acceleration with a movement of a user, wherein
the operation-contents recognizing unit recognizes the contents of the operation of the appliance identified by the appliance-identifying unit, based on the acceleration detected by the acceleration sensor.

11. The device according to claim 1, further comprising:
an operation-contents instructing unit that enables a user to instruct desired contents of the operation, wherein
the operation-contents recognizing unit recognizes the contents of the operation instructed from the user through the operation-contents instructing unit.

12. The device according to claim 2, wherein
the operation-contents recognizing unit recognizes the contents of the operation of the appliance identified by the appliance-identifying unit, based on an acceleration with a movement of a user.

13. The device according to claim 12, wherein
when the vertical-direction detecting unit employs an acceleration senor, the operation-contents recognizing unit detects the acceleration with the movement of the user using the acceleration senor employed by the vertical-direction detecting unit.

14. The device according to claim 1, wherein
the operation-command transmitting unit directly transmits the operation command to the appliance identified by the appliance-identifying unit, by an infrared communication using an infrared light emitting diode.

15. The device according to claim 14, wherein
when the distance detecting unit measures the distance using the infrared light emitting diode, and
the operation-command transmitting unit directly transmits the operation command to the appliance identified by the appliance-identifying unit, using the infrared light emitting diode employed by the distance detecting unit.

16. The device according to claim 1, wherein
the operation-command transmitting unit directly transmits the operation command to the appliance identified by the appliance-identifying unit, by a wireless communication using a wireless communicating unit.

17. The device according to claim 1, wherein
when the appliance is connected to the appliance-operating device via a network, the operation-command transmitting unit transmits the operation command including an address of the appliance.

18. A method of operating an appliance, the method comprising:
detecting a start of operation of the appliance from an action of pointing at the appliance;
detecting, when the start of the operation of the appliance is detected, a direction of the appliance;
detecting, when the start of the operation of the appliance is detected, a distance to the appliance;
identifying the appliance by referring to room information of a room in which the appliance is installed and position information of the appliance in the room stored in a room-information database, the room information including information on a configuration and a dimension of the room, based on an operation vector generated from the direction and the distance of the appliance;
recognizing contents of the operation of the appliance;
generating an operation command for operating the appliance from an operation command stored in an operation-command database, based on the contents of the operation recognized at the recognizing; and
transmitting the operation command generated at the generating to the appliance identified at the identifying.

19. The method according to claim 18, wherein
the identifying includes identifying the appliance by narrowing a range of an area in which the appliance is positioned from the room information stored in the room-information database, based on the operation vector.

20. The method according to claim 18, wherein
the identifying includes identifying the appliance by calculating an inverse vector of the operation vector from the room information and the position information stored in the room-information database, based on the operation vector.
